(19) United States
(12) Patent Application Publication
(10) Pub. No.: US 2026/0161333 A1
(43) Pub. Date: Jun. 11, 2026

(54) PRINT CONTROL APPARATUS, PRINT CONTROL METHOD, AND STORAGE MEDIUM

(71) Applicant: SEIKO EPSON CORPORATION, Tokyo (JP)

(72) Inventor: Sho IWASAKI, Azumino (JP)

(21) Appl. No.: 19/407,025

(22) Filed: Dec. 3, 2025

(30) Foreign Application Priority Data
Dec. 5, 2024 (JP) 2024-211972

(51) Int. Cl. G06F 3/12; G06F 3/14

(52) U.S. Cl. CPC G06F 3/1208; G06F 3/1204; G06F 3/1205; G06F 3/1255; G06F 3/1286; G06F 3/1423

(57) ABSTRACT

A controller controls combined printing of a plurality of documents. The controller includes a first configuration setting unit and a display control unit. The first configuration setting unit sets, for a first configuration item that is a configuration item included in a first category among a plurality of configuration items specifying processing content of a document, a default value of the first configuration item to the first configuration item of each of the plurality of documents. The display control unit causes a display mechanism to display that setting of the first configuration item by a user is not possible.

The present application is based on, and claims priority from JP Application Serial Number 2024-211972, filed Dec. 5, 2024, the disclosure of which is hereby incorporated by reference herein in its entirety.

### BACKGROUND

### 1. Technical Field

The present disclosure relates to a print control apparatus, a print control method, and a storage medium.

### 2. Related Art

JP-A-2009-259021 discloses the following.

That is, documents created by a personal computer, images read by a scanner, and the like are stored in a printer, and a plurality of stored documents are combined into one document and printed. When mutually contradictory print settings are specified for respective documents of a plurality of documents to be combined and printed, it is necessary to change, for example, the print settings for one of the documents to be combined. When mutually contradictory print settings are specified for the plurality of documents to be combined and printed, selection of a configuration item is permitted for the contradictory print settings.

However, in the technique described in JP-A-2009-259021, since one of the contradictory settings is selected in the combined printing, the output result differs from the case where each of the plurality of documents is output independently. Therefore, there is a problem in that a printed result desired by the user may not be obtained.

### SUMMARY

According to an aspect of the present disclosure, there is provided a print control apparatus for controlling combined printing of a plurality of documents. The print control apparatus includes a first configuration setting unit configured to set, for a first configuration item that is a configuration item included in a first category among a plurality of configuration items specifying processing content of a document, a default value of the first configuration item to the first configuration item of each of the plurality of documents; and a display control unit configured to cause a display mechanism to display that setting of the first configuration item by a user is not possible.

### BRIEF DESCRIPTION OF THE DRAWINGS

FIG. 1 is a diagram illustrating an example configuration of a printer according to the present embodiment.

FIG. 2 is a block diagram illustrating an example configuration of a controller according to the present embodiment.

FIG. 3 is a table depicting example configuration items included in a first category or a second category.

FIG. 4 is a table depicting example configuration items included in a third category.

FIG. 5 is a screen diagram illustrating example screen transitions performed by a display control unit.

FIG. 6 is a flowchart illustrating an example process performed by a controller.

### DESCRIPTION OF EMBODIMENTS

The present embodiment will be described with reference to the accompanying drawings.

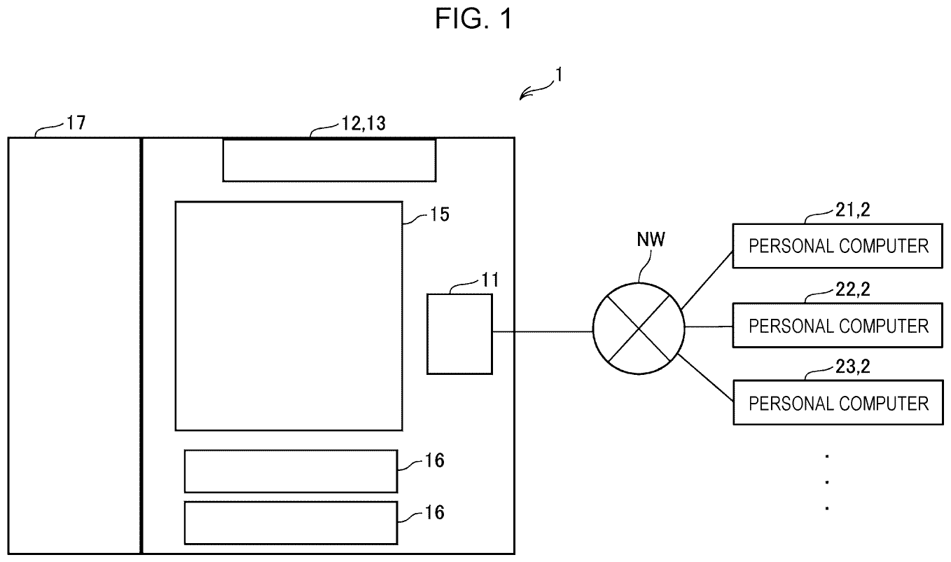

First, with reference to FIG. 1, the configuration of a printer 1 according to the present embodiment will be described. FIG. 1 is a diagram illustrating an example configuration of a printer 1 according to the embodiment.

As illustrated in FIG. 1, the printer 1 is communicatively coupled to a plurality of personal computers 2 via a network NW.

The network NW is, for example, a local area network (LAN).

The plurality of personal computers 2 include, for example, a first personal computer 21, a second personal computer 22, and a third personal computer 23.

In response to a user instruction, each of the plurality of personal computers 2 causes the document data DD to be stored in a document storage unit 118 of a memory 11B of the printer 1.

Additionally, in response to a user instruction, each of the plurality of personal computers 2 may instruct the printer 1 to perform combined printing. The term “combined printing” refers to printing, as one job, a plurality of pieces of the document data DD stored in the document storage unit 118. Printing the document data DD stored in the document storage unit 118 corresponds to an example of so-called “box printing”. That is, “combined printing” in the present embodiment corresponds to “combined printing” in “box printing”.

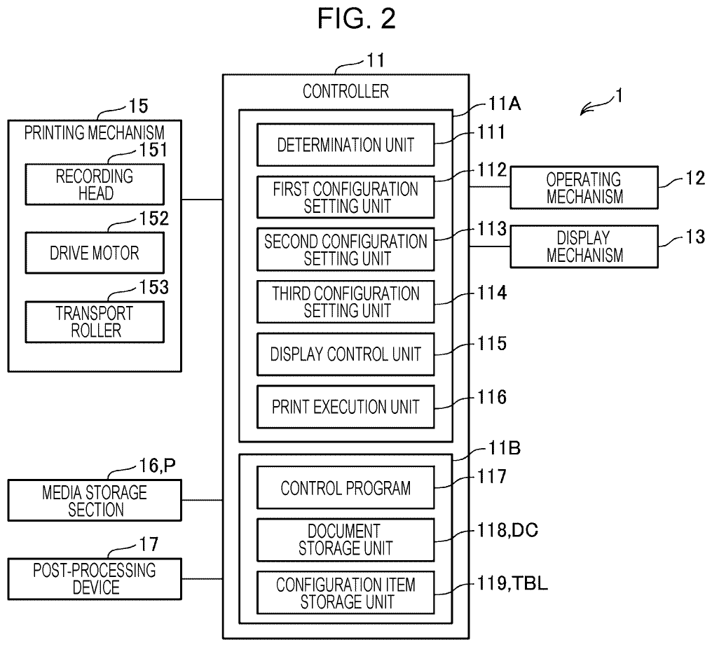

The document storage unit 118 will further be described with reference to FIG. 2.

The printer 1 includes a controller 11, an operating mechanism 12, a display mechanism 13, a printing mechanism 15, a media storage section 16, and a post-processing device 17.

The controller 11 controls operations of components of the printer 1. Each of the operating mechanism 12, the display mechanism 13, the printing mechanism 15, the media storage section 16, and the post-processing device 17 is configured to be communicatively coupled to the controller 11.

The operating mechanism 12 is disposed in an upper portion of the printer 1. The operating mechanism 12 includes an input unit such as an operating switch or a touch panel provided in the printer 1, detects a user operation on the input unit, and outputs a detection signal corresponding to the operation to the controller 11. The controller 11 executes, based on an input from the operating mechanism 12, a process corresponding to the user operation.

The display mechanism 13 is disposed in an upper portion of the printer 1. The display mechanism 13 includes a plurality of light emitting diodes (LEDs) and a display panel such as a liquid crystal display (LCD). Under control of the controller 11, the display mechanism 13 turns the LEDs on and off, makes them blink, displays information on the display panel, and performs other operations in a predetermined manner.

The display panel constitutes a portion of a touch panel disposed in the operating mechanism 12. That is, the touch panel includes the display panel and a touch sensor. The touch sensor is disposed on a display surface of the display panel and detects a user's touch operation. The touch sensor outputs a signal corresponding to the detected touch operation to the controller 11.

The printing mechanism 15 performs printing under control of the controller 11. Specifically, under control of the controller 11, the printing mechanism 15 prints characters, images, and the like on a recording medium P such as a sheet of printing paper.

The configuration of the printing mechanism 15 will further be described with reference to FIG. 2.

The media storage section 16 is configured to be able to store the recording medium P. For example, sheets of the recording medium P are stacked and stored in the media storage section 16. Under control of the controller 11, the media storage section 16 feeds a sheet of the recording medium P located at the uppermost position among the stacked sheets to a transport path (not illustrated).

The post-processing device 17 performs post-processing on the recording medium P printed by the printing mechanism 15. The post-processing device 17 includes, for example, a stapler, a puncher, a sorter, and a folding mechanism.

The stapler stacks sheets of the recording medium P for each copy and fastens one end of the sheets for each copy by driving a staple. One copy is composed of a plurality of sheets of the recording medium P.

The puncher punches a hole in an end portion on one side of the recording medium P.

The sorter performs a process of stacking each copy of sheets of the recording medium P.

The folding mechanism folds a sheet of the recording medium P in two or three.

Next, with reference to FIG. 2, the configuration of the controller 11 will be described. FIG. 2 is a block diagram illustrating an example configuration of the controller 11 according to the present embodiment.

The controller 11 includes a processor 11A, such as a central processing unit (CPU), and a memory 11B, such as a read-only memory (ROM). The memory 11B stores a control program 117.

The controller 11 corresponds to an example of a print control apparatus.

The processor 11A may be composed of a plurality of processors or may be a single processor.

The processor 11A may be hardware that is programmed to implement the functions of the components described below. That is, the processor 11A may have a configuration in which the control program 117 is provided as a hardware circuit. In this case, for example, the processor 11A is implemented by an application-specific integrated circuit (ASIC), a field-programmable gate array (FPGA), or the like.

In the following description, a case is described in which various functions of the controller 11 are implemented by the processor 11A executing the control program 117.

The memory 11B has a nonvolatile storage area for storing programs and data in a nonvolatile manner. The memory 11B may include, for example, a ROM, a hard disk drive (HDD), a solid-state drive (SSD), or the like as a nonvolatile storage area. Additionally, the memory 11B may include a volatile storage area serving as a work area for temporarily storing a program to be executed by the processor 11A or data to be processed by the processor 11A. The memory 11B may include, for example, a random-access memory (RAM) as the volatile storage area.

In the present embodiment, the processor 11A controls components of the printer 1 by executing the control program 117; however, the way of controlling components is not limited to this. The controller 11 may include, for example, an ASIC, and the ASIC may execute processing using its implemented function. Additionally, the controller 11 may include, for example, a signal processing circuit, and the signal processing circuit may perform signal processing for execution of processing.

As illustrated in FIG. 2, the printing mechanism 15 includes a recording head 151, a drive motor 152, and a transport roller 153, which constitute an example configuration related to printing.

The recording head 151 is, for example, an ink jet recording head. That is, in the present embodiment, the printer 1 is an ink jet printer. The recording head 151 forms an image on the recording medium P by ejecting ink toward the recording medium P.

The drive motor 152 drives the transport roller 153. The drive motor 152 is, for example, a direct-current (DC) motor.

The transport roller 153 transports the recording medium P from the media storage section 16 toward the recording head 151. Additionally, the transport roller 153 transports the recording medium P, on which an image has been formed by the recording head 151, to the post-processing device 17.

Next, functional blocks included in the controller 11 of the printer 1 will be described.

The controller 11 includes a determination unit 111, a first configuration setting unit 112, a second configuration setting unit 113, a third configuration setting unit 114, a display control unit 115, a print execution unit 116, the document storage unit 118, and a configuration item storage unit 119.

By executing the control program 117, the processor 11A functions as the determination unit 111, the first configuration setting unit 112, the second configuration setting unit 113, the third configuration setting unit 114, and the print execution unit 116. Additionally, by executing the control program 117, the processor 11A causes the memory 11B to function as the document storage unit 118 and the configuration item storage unit 119.

The control program 117 corresponds to an example of a program.

The document storage unit 118 stores a plurality of pieces of document data DD.

The document storage unit 118 is divided into a plurality of areas. A user is associated with each of the plurality of areas. For example, the user of the first personal computer 21 is associated with a first area. For example, the user of the second personal computer 22 is associated with a second area. For example, the user of the third personal computer 23 is associated with a third area.

The plurality of pieces of document data DD are stored in each of the first area, the second area, and the third area. Each of the first area, the second area, and the third area corresponds to a so-called “box”.

For example, the user of the first personal computer 21 selects a plurality of documents DC, for which combined printing is to be performed, from among the plurality of pieces of document data DD stored in the first area. The user of the first personal computer 21 then instructs the printer 1 to perform the combined printing of the selected plurality of documents DC.

For example, the user of the second personal computer 22 selects a plurality of documents DC for which the combined printing is to be performed, from among the plurality of pieces of document data DD stored in the second area. The user of the second personal computer 22 then instructs the printer 1 to perform the combined printing of the selected plurality of documents DC.

For example, the user of the third personal computer 23 selects a plurality of documents DC for which the combined printing is to be performed, from among the plurality of pieces of document data DD stored in the third area. The user of the third personal computer 23 then instructs the printer 1 to perform the combined printing of the selected plurality of documents DC.

The document data DD is generated by various application programs installed in the personal computer 2. Additionally, the document data DD may be generated by an image reading apparatus, that is, a so-called scanner.

The document data DD includes setting value data of a plurality of configuration items JS that define the content of processing performed by the printer 1. The processing performed by the printer 1 includes printing and post-processing.

The configuration item storage unit 119 stores information indicating whether each of the plurality of configuration items JS, which defines the content of processing performed by the printer 1, is a third configuration item JS3, a first configuration item JS1, or a second configuration item JS2, for example, in a table TBL.

The first configuration item JS1 is a configuration item JS included in a first category CT1. The second configuration item JS2 is a configuration item JS included in a second category CT2. The third configuration item JS3 is a configuration item JS included in a third category CT3.

Additionally, when the configuration item JS is the first configuration item JS1, the configuration item storage unit 119 stores a default value DF of the setting value of the configuration item JS in the table TBL.

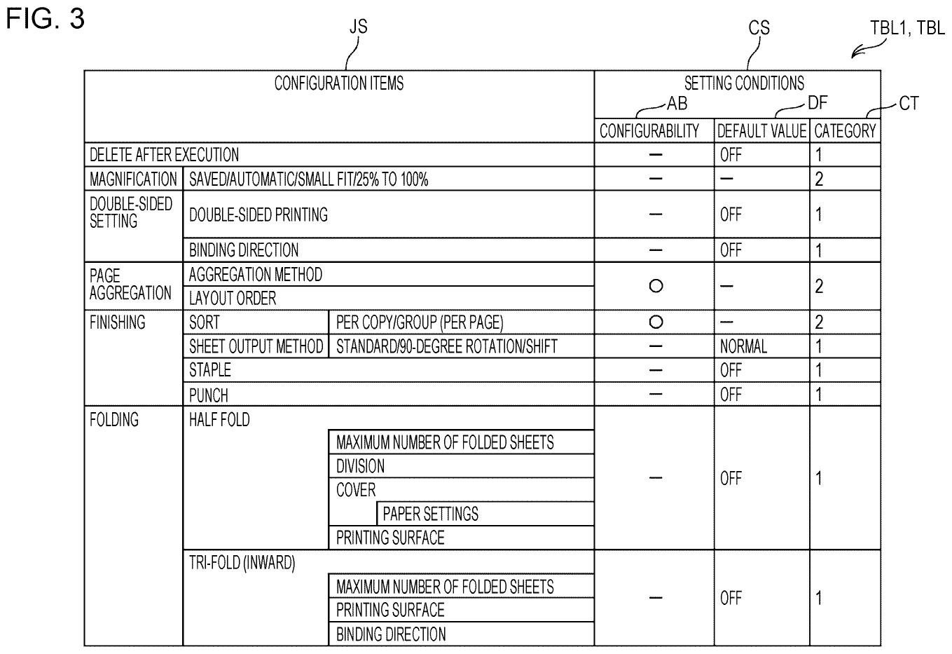

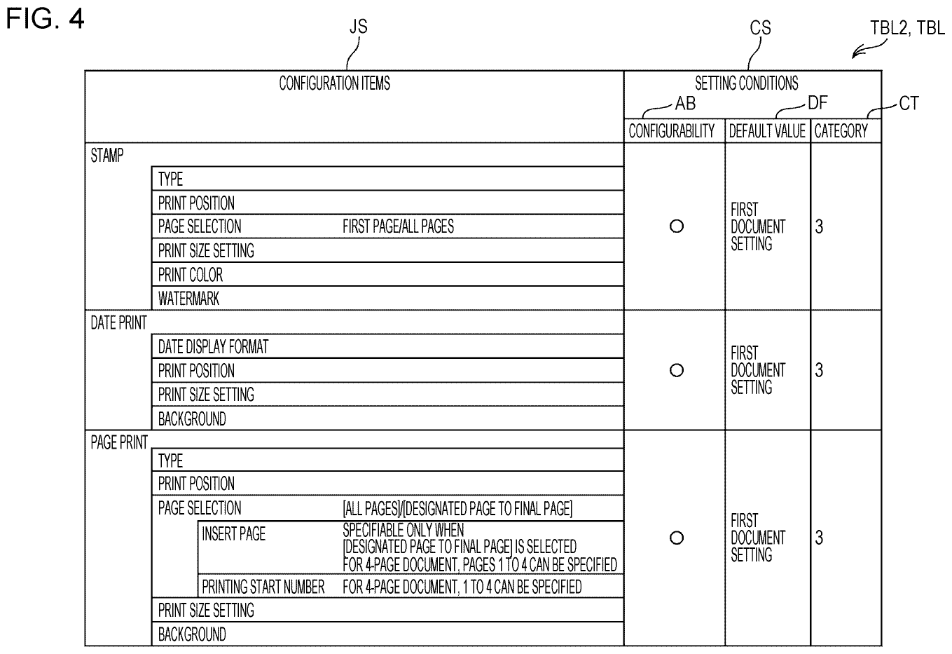

The table TBL will further be described with reference to FIGS. 3 and 4.

By referring to the table TBL stored in the configuration item storage unit 119, the determination unit 111 determines whether each of the plurality of configuration items JS defining the content of processing performed by the printer 1 is the first configuration item JS1, the second configuration item JS2, or the third configuration item JS3.

The first configuration item JS1 is a configuration item JS included in the first category CT1. The second configuration item JS2 is a configuration item JS included in the second category CT2. The third configuration item JS3 is a configuration item JS included in the third category CT3.

When the configuration item JS is the first configuration item JS1, the first configuration setting unit 112 sets the setting value of the first configuration item JS1 of each of a plurality of documents DC selected for combined printing to the default value DF of the first configuration item JS1.

For example, processing by the first configuration setting unit 112 is described for the case where the plurality of documents DC are a first document DCA, a second document DCB, and a third document DCC.

The first configuration setting unit 112 sets the default value DF of the first configuration item JS1 to the setting value of the first configuration item JS1 of each of the first document DCA, the second document DCB, and the third document DCC.

The first configuration item JS1 will further be described with reference to FIG. 3.

When the configuration item JS is the second configuration item JS2, the second configuration setting unit 113 holds the setting value of the second configuration item JS2 of each of the plurality of documents DC.

For example, processing by the second configuration setting unit 113 is described for the case where the plurality of documents DC include the first document DCA, the second document DCB, and the third document DCC.

The second configuration setting unit 113 holds the setting value for the second configuration item JS2 of each of the first document DCA, the second document DCB, and the third document DCC.

In other words, the second configuration setting unit 113 holds the setting value of the second configuration item JS2 in the document data DD corresponding to the first document DCA as the setting value of the second configuration item JS2 to be used when the first document DCA is processed in combined printing. Additionally, the second configuration setting unit 113 holds the setting value of the second configuration item JS2 in the document data DD corresponding to the second document DCB as the setting value of the second configuration item JS2 to be used when the second document DCB is processed in combined printing. Furthermore, the second configuration setting unit 113 holds the setting value of the second configuration item JS2 in the document data DD corresponding to the third document DCC as the setting value of the second configuration item JS2 to be used when the third document DCC is processed in combined printing.

The second configuration item JS2 will further be described with reference to FIG. 3.

In the present embodiment, the case where the second configuration setting unit 113 holds the setting value of the second configuration item JS2 of each of the plurality of documents DC is described; however, the embodiments are not limited to this.

For example, the second configuration setting unit 113 may set the setting value of the second configuration item JS2 of each of the plurality of documents DC based on a user operation.

Additionally, for example, the second configuration setting unit 113 may select whether to set the setting value of the second configuration item JS2 based on a user operation, to set the setting value of the second configuration item JS2 to the default value DF of the second configuration item JS2, or to hold the setting value of the second configuration item JS2 of each of the plurality of documents DC.

When the configuration item JS is the third configuration item JS3, the third configuration setting unit 114 sets the setting value of the third configuration item JS3 of one of the plurality of documents DC as the setting value of the third configuration item JS3 of each of the plurality of documents DC.

For example, when a plurality of documents DC for combined printing are selected by the user of the personal computer 2, the third configuration setting unit 114 sets the setting value of the third configuration item JS3 of the document DC selected first as the setting value of the third configuration item JS3 for each of the plurality of documents DC.

For example, processing by the third configuration setting unit 114 is described for the case where the plurality of documents DC include the first document DCA, the second document DCB, and the third document DCC.

If the first document DCA is selected first when the plurality of documents DC for combined printing are selected by the user of the personal computer 2, the third configuration setting unit 114 performs the following processing. That is, the third configuration setting unit 114 sets the setting value of the third configuration item JS3 in the document data DD corresponding to the first document DCA as the setting value of the third configuration item JS3 for each of the first document DCA, the second document DCB, and the third document DCC.

If the second document DCB is selected first when the plurality of documents DC for combined printing are selected by the user of the personal computer 2, the third configuration setting unit 114 performs the following processing. That is, the third configuration setting unit 114 sets the setting value of the third configuration item JS3 in the document data DD corresponding to the second document DCB as the setting value of the third configuration item JS3 for each of the first document DCA, the second document DCB, and the third document DCC.

If the third document DCC is selected first when the plurality of documents DC for combined printing are selected by the user of the personal computer 2, the third configuration setting unit 114 performs the following processing. That is, the third configuration setting unit 114 sets the setting value of the third configuration item JS3 in the document data DD corresponding to the third document DCC as the setting value of the third configuration item JS3 for each of the first document DCA, the second document DCB, and the third document DCC.

The third configuration item JS3 will further be described with reference to FIG. 4.

The display control unit 115 causes the display mechanism 13 to display that setting of the first configuration item JS1 by the user is not possible.

For example, the display control unit 115 causes the display mechanism 13 to display, by graying out a first setting button BS1 for setting the first configuration item JS1, that the setting of the first configuration item JS1 by the user is not possible.

Additionally, when setting of the first configuration item JS1 is to be made possible by changing at least one setting value of the second configuration item JS2, the display control unit 115 causes the display mechanism 13 to display that the setting of the first configuration item JS1 is made possible.

For example, processing by the display control unit 115 is described for the case where the plurality of documents DC include the first document DCA, the second document DCB, and the third document DCC.

For example, “sheet output method” of “finishing” is an example of the first configuration item JS1. Therefore, the first configuration setting unit 112 sets “sheet output method” of “finishing” to “normal”, which is the default value DF, for each of the plurality of documents DC.

Additionally, for example, “page aggregation” is an example of the second configuration item JS2.

For example, when “page aggregation” is set for the third document DCC, the “sheet output method” of “finishing” cannot be set to “90-degree rotation” for each of the plurality of documents DC.

In such a case, by setting the “page aggregation” of the third document DCC to “off”, setting of the “sheet output method” of the “finishing” to “90-degree rotation” is possible.

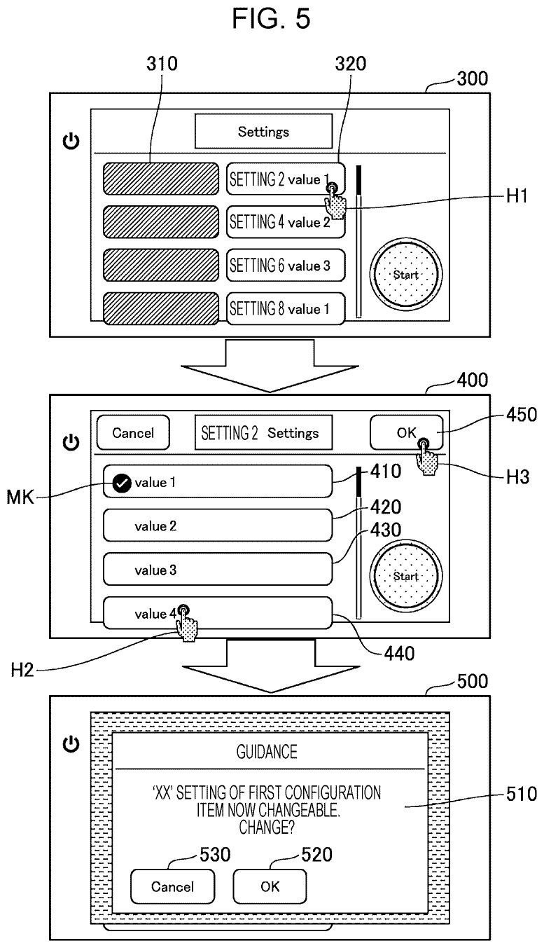

The case where, as described above, setting of the first configuration item JS1 is to be made possible by changing at least one setting value of the second configuration item JS2 will further be described with reference to FIG. 5.

The print execution unit 116 performs combined printing of the plurality of documents DC using the setting values of the first configuration item JS1, the second configuration item JS2, and the third configuration item JS3, which are set by the first configuration setting unit 112, the second configuration setting unit 113, and the third configuration setting unit 114.

The setting value of the first configuration item JS1 is set for each of the plurality of documents DC by the first configuration setting unit 112. The setting value of the second configuration item JS2 is set for each of the plurality of documents DC by the second configuration setting unit 113. The setting value of the third configuration item JS3 is set for each of the plurality of documents DC by the third configuration setting unit 114.

Next, with reference to FIG. 3, the first configuration item JS1 and the second configuration item JS2 will further be described. FIG. 3 is a table depicting example configuration items JS included in the first category CT1 or the second category CT2.

FIG. 3 depicts a first table TBL1 stored in the configuration item storage unit 119. The first table TBL1 lists example configuration items JS included in the first category CT1 or the second category CT2.

In the first table TBL1, configuration items JS and setting conditions CS are listed from left to right. The setting conditions CS include configurability AB, default value DF, and category CT.

The number in the category CT corresponding to each configuration item JS listed in the first table TBL1 is “1” or “2”, which indicates that each configuration item JS is included in the first category CT1 or the second category CT2.

The configurability AB indicates whether setting by an operation from the user is possible.

The mark in the configurability AB corresponding to each of the first configuration items JS1 listed in the first table TBL1 is “−”, which indicates that setting of each of the first configuration items JS1 by an operation from the user is not possible.

The mark in the configurability AB corresponding to each of the second configuration items JS2 listed in the first table TBL1 is “○”, which indicates that setting of each of the second configuration items JS2 by an operation from the user is possible.

When the configuration item JS is the first configuration item JS1, the default value DF corresponding to each of the first configuration items JS1 is indicated in the column of the default value DF.

When the configuration item JS is the second configuration item JS2, the default value DF corresponding to each of the second configuration items JS2 is not indicated in the column of the default value DF.

The first configuration items JS1 listed in the first table TBL1 include, for example, “staple” and “punch”.

The item “staple” indicates whether to stack sheets of the recording medium P for each copy and to staple one end of sheets of the recording medium P for each copy. This processing is performed by the stapler of the post-processing device 17.

The item “punch” indicates whether to punch a hole in one end of the recording medium P. This processing is performed by the puncher of the post-processing device 17.

As described above, the first configuration setting unit 112 sets the setting value of the first configuration item JS1 to the default value DF. Therefore, for example, when the configuration item JS is “staple” or “punch”, the setting value of the configuration item JS is set to “off”, which is the default value DF.

The second configuration items JS2 listed in the first table TBL1 include, for example, “magnification”, “page aggregation”, and “sort”.

The item “magnification” refers to an enlargement/reduction ratio of an image formed on the recording medium P.

The item “page aggregation” refers to forming images of a plurality of pages on a single sheet of the recording medium P. The item “page aggregation” includes so-called “2-in-1”. The term “2-in-1” indicates printing images of two pages in a reduced size on a single sheet of the recording medium P.

The item “sort” refers to processing of stacking sheets of the recording medium P for each copy. The processing referred to as “sort” is performed by the sorter of the post-processing device 17.

Next, with reference to FIG. 4, the third configuration items JS3 will further be described. FIG. 4 is a table depicting an example of the configuration items JS included in the third category CT3.

FIG. 4 depicts a second table TBL2 stored in the configuration item storage unit 119. The second table TBL2 lists an example of the configuration items JS included in the third category CT3.

In the second table TBL2, the configuration items JS and the setting conditions CS are listed from left to right. The setting conditions CS include the configurability AB, the default value DF, and the category CT.

The number in the category CT corresponding to each configuration item JS listed in the second table TBL2 is “3”, which indicates that each configuration item JS is included in the third category CT3, that is, each configuration item JS is the third configuration item JS3.

The configurability AB indicates whether setting by an operation from the user is possible. The mark in the configurability AB corresponding to each of the third setting items JS3 listed in the second table TBL2 is “○”, which indicates that setting of each of the configuration items JS by an operation from the user is possible.

The term in the default value DF is “first document setting”. This indicates that, as described above, when a plurality of documents DC for combined printing are selected by the user, the first configuration setting unit 112 sets the setting value of the third configuration item JS3 of the document DC selected first as the setting value of the third configuration item JS3 for each of the plurality of documents DC.

The third configuration items JS3 listed in the second table TBL2 include, for example, “stamp”, “date print”, and “page print”.

The item “stamp” indicates printing a stamp, such as “confidential”, for example, in a predetermined size at a predetermined position in the upper margin of the recording medium P.

The item “date print” indicates printing characters representing a date of printing, for example, in a predetermined size at a predetermined position in the bottom margin of the recording medium P.

The item “page print” indicates printing characters representing a page number in the document DC, for example, in a predetermined size at a predetermined position in the bottom margin of the recording medium P.

Next, with reference to FIG. 5, the processing of the display control unit 115 will further be described. FIG. 5 is a screen diagram illustrating example screen transitions performed by the display control unit 115.

For example, processing by the display control unit 115 is described for the case where the plurality of documents DC include the first document DCA, the second document DCB, and the third document DCC.

In the initial state, for example, since “sheet output method” of “finishing” is an example of the first configuration item JS1, the first configuration setting unit 112 sets the default value DF of “sheet output method” of “finishing” to “normal”.

Additionally, for example, since “page aggregation” is an example of the second configuration item JS2, when “page aggregation” is set for the third document DCC, the setting of “page aggregation” is held for the third document DCC by the second configuration setting unit 113.

Accordingly, when “page aggregation” is set for the third document DCC, “sheet output method” of “finishing” cannot be set to “90-degree rotation” for each of the plurality of documents DC.

The display control unit 115 first causes the display mechanism 13 to display a first screen 300 illustrated at the top of FIG. 5. A list of configuration items is displayed on the first screen 300.

First buttons 310 and second buttons 320 are displayed on the first screen 300.

For example, since the first button 310 is a button for setting the first configuration item JS1, setting of this button by an operation from the user is not possible. The display control unit 115 causes the display mechanism 13 to display, by graying out the first setting button 310, that the setting of the first configuration item JS1 by the user is not possible.

Hatching applied to the first button 310 indicates gray-out display.

The first button 310 is, for example, a button for setting “sheet output method” of “finishing”.

For example, since the second button 320 is a button for setting the second configuration item JS2, setting by an operation from the user is possible. The display control unit 115 causes the display mechanism 13 not to gray out the second button 320, that is, the display control unit 115 causes the display mechanism 13 to normally display the second button 320, thereby displaying that setting of the second configuration item JS2 by the user is possible.

The second button 320 is, for example, a button for setting “page aggregation”.

When the user performs a touch operation on the second button 320 as indicated by a hand H1, the display control unit 115 causes the display mechanism 13 to display a second screen 400 illustrated in the middle of FIG. 5.

The second screen 400 is, for example, a setting screen of “page aggregation”.

A first button 410, a second button 420, a third button 430, a fourth button 440, and an OK button 450 are displayed on the second screen 400.

The first button 410 indicates, for example, that “page aggregation” is set for the third document DCC.

A selection mark MK is displayed on the first button 410. The selection mark MK indicates that a setting value corresponding to the first button 410 is set. That is, the selection mark MK indicates, for example, that “page aggregation” is set for the third document DCC.

The fourth button 440 indicates, for example, that “page aggregation” set for the third document DCC will be set to “OFF”.

The OK button 450 is a button to be touched by the user to change a setting value.

When the user performs a touch operation on the fourth button 440 as indicated by a hand H2 and then touches the OK button 450 as indicated by a hand H3, the second configuration setting unit 113 sets “page aggregation” set for the third document DCC to “OFF”. Then, the display control unit 115 causes the display mechanism 13 to display a third screen 500 illustrated at the bottom of FIG. 5.

Guidance is displayed on the third screen 500.

On the third screen 500, a guidance display portion 510, an OK button 520, and a cancel button 530 are displayed.

On the guidance display portion 510, a guidance reading “'XX′ setting of first configuration item now changeable. Change?” is displayed.

Here, “XX” is, for example, the “sheet output method” of “finishing”.

That is, the guidance displayed on the guidance display portion 510 indicates that setting of “sheet output method” of “finishing”, which is the first configuration item JS1, is made possible as a result of the “page aggregation” of the third document DCC being set to “OFF”.

The OK button 520 is a button to be touched by the user to display a screen for changing a setting value of “sheet discharge method” of “finishing”.

When the user performs a touch operation on the OK button 520, the display control unit 115 causes the display mechanism 13 to display a screen for changing the setting value of “sheet output method” of “finishing”.

When the screen for changing the setting value of “paper discharge method” of “finishing” is displayed, the user sets “sheet output method” of “finishing” to “90-degree rotation” for each of the plurality of documents DC, for example.

The cancel button 530 is a button to be touched by the user when the user does not change the setting value of “sheet output method” of “finishing”.

When the user performs a touch operation on the cancel button 530, the display control unit 115 causes the display mechanism 13 to display, for example, the first screen 300 illustrated at the top of FIG. 5.

As described above, when setting of the first configuration item JS1 is made possible by changing at least one setting value of the second configuration item JS2, the display control unit 115 causes the display mechanism 13 to display that setting of the first configuration item JS1 by the user is made possible.

With reference to FIG. 5, it has been described that when setting of the first configuration item JS1 is made possible by changing at least one setting value of the second configuration item JS2, the display control unit 115 causes the display mechanism 13 to display that setting of the first configuration item JS1 by the user is made possible. Embodiments are not limited to this.

For example, when setting of the first configuration item JS1 is to be made possible by changing at least setting value of the second configuration item JS2, the display control unit 115 may cause the display mechanism 13 to display that setting of the first configuration item JS1 by the user is to be made possible. In this case, the display mechanism 13 displays that setting of the first configuration item JS1 is to be made possible by changing at least one setting value of the second configuration item JS2.

The user visually recognizes that setting of the first configuration item JS1 is to be made possible by changing at least one setting value of the second configuration item JS2. This may improve user convenience.

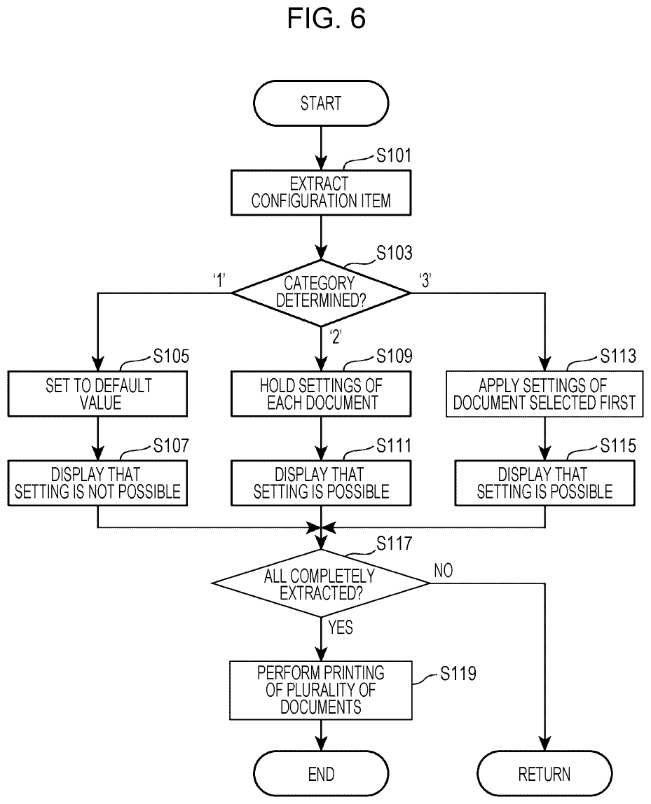

Next, with reference to FIG. 6, processing of the controller 11 in the present embodiment will be described. FIG. 6 is a flowchart illustrating an example process of the controller 11.

As illustrated in FIG. 6, first, in step S101, the determination unit 111 sequentially extracts each of the plurality of configuration items JS that define the content of processing performed by the printer 1.

Next, in step S103, with reference to the table TBL stored in the configuration item storage unit 119, the determination unit 111 determines whether the configuration item JS extracted in step S101 is the third configuration item JS3, the first configuration item JS1, or the second configuration item JS2.

If the determination unit 111 determines that the extracted configuration item JS is the first configuration item JS1 (step S103; “1”), the process proceeds to step S105.

In step S105, the first configuration setting unit 112 sets the default value DF of the first configuration item JS1 to the first configuration item JS1 of each of the plurality of documents DC.

Next, in step S107, the display control unit 115 causes the display mechanism 13 to display that setting of the first configuration item JS1 by the user is not possible. For example, the display control unit 115 causes the display mechanism 13 to display, by graying out the first setting button for setting the first configuration item JS1, that setting of the first configuration item JS1 by the user is not possible. The process then proceeds to step S117.

If the determination unit 111 determines that the extracted configuration item JS is the second configuration item JS2 (step S103; “2”), the process proceeds to step S109.

In step S109, the second configuration setting unit 113 holds the setting value of the second configuration item JS2 for each of the plurality of documents DC.

Next, in step S111, the display control unit 115 causes the display mechanism 13 to display that setting of the second configuration item JS2 by the user is possible. For example, the display control unit 115 causes the display mechanism 13 to normally display the second setting button for setting the second configuration item JS2, thereby displaying that setting of the second configuration item JS2 by the user is possible. The process then proceeds to step S117.

If the determination unit 111 determines that the extracted configuration item JS is the third configuration item JS3 (step S103; “3”), the process proceeds to step S113.

In step S113, for example, when a plurality of documents DC for combined printing are selected by the user, the third configuration setting unit 114 sets the setting value of the third configuration item JS3 of the document DC selected first as the setting value of the third configuration item JS3 for each of the plurality of documents DC.

Next, in step S115, the display control unit 115 causes the display mechanism 13 to display that setting of the third configuration item JS3 by the user is possible. For example, the display control unit 115 causes the display mechanism 13 to normally display the third setting button for setting the third configuration item JS3, thereby displaying that setting of the third configuration item JS3 by the user is possible. The process then proceeds to step S117.

Next, in step S117, the determination unit 111 determines whether all of the plurality of configuration items JS have been extracted.

If the determination unit 111 determines that all of the plurality of configuration items JS have not been extracted (step S117; NO), the process returns to step S101. If the determination unit 111 determines that all of the plurality of configuration items JS have been extracted (step S117; YES), the process proceeds to step S119.

Then, in step S119, the print execution unit 116 performs combined printing of the plurality of documents DC. Thereafter, the process terminates.

### Configuration and Effects

As described above with reference to FIGS. 1 to 6, the controller 11 according to the present embodiment is the controller 11 for controlling combined printing of the plurality of documents DC. The controller 11 includes the first configuration setting unit 112 configured to set, for the first configuration item JS1 that is a configuration item included in the first category CT1 among the plurality of configuration items JS specifying processing content of the document DC, the default value DF of the first configuration item JS1 to the first configuration item JS1 of each of the plurality of documents DC, and the display control unit 115 configured to cause the display mechanism 13 to display that setting of the first configuration item JS1 by a user is not possible.

According to this configuration, for the first configuration item JS1, which is a configuration item included in the first category CT1 among the plurality of configuration items JS defining the processing content of the document DC, the default value DF of the first configuration item JS1 is set to the first configuration item JS1 of each of the plurality of documents DC. Therefore, by setting the default value DF to an appropriate value, the setting value of the first configuration item JS1 of each of the plurality of documents DC can be appropriately set. Accordingly, a printed result desired by the user can be obtained. Additionally, since the display mechanism 13 is caused to display that the setting of the first configuration item JS1 by the user is not possible, the user can visually recognize that the setting of the first configuration item JS1 is not possible. This may improve user convenience.

In the controller 11 according to the present embodiment, the display control unit 115 is configured to cause the display mechanism 13 to display, by graying out the first setting button for setting the first configuration item JS1, that the setting of the first configuration item JS1 by the user is not possible.

According to this configuration, the display mechanism 13 is caused to display, by graying out the first setting button for setting the first configuration item JS1, that setting of the first configuration item JS1 by the user is not possible. Therefore, the user can easily visually recognize that the setting of the first configuration item JS1 is not possible. This may improve user convenience.

The controller 11 according to the present embodiment further includes the second configuration setting unit 113 configured to hold, for the second configuration item JS2 that is the configuration item JS included in the second category CT2 different from the first category CT1 among the plurality of configuration items JS, a setting value of the second configuration item JS2 of each of the plurality of documents DC. The display control unit 115 is configured to cause, when setting of the first configuration item JS1 is to be made possible by changing at least one setting value of the second configuration item JS2, the display mechanism 13 to display that the setting of the first configuration item JS1 is made possible.

According to this configuration, for the second configuration item JS2, which is the configuration item JS included in the second category CT2 different from the first category CT1 among the plurality of configuration items JS, the setting value of the second configuration item JS2 of each of the plurality of documents DC is held. Therefore, by appropriately setting the second configuration item JS2, a printed result desired by the user can be obtained.

In the controller 11 according to the present embodiment, when setting of the first configuration item JS1 is made possible by changing the at least one setting value of the second configuration item JS2, the display control unit 115 causes the display mechanism 13 to display that setting of the first configuration item JS1 by a user is made possible.

According to this configuration, when setting of the first configuration item JS1 is made possible by changing the at least one setting value of the second configuration item JS2, the display mechanism 13 is caused to display that setting of the first configuration item JS1 by the user is made possible. Therefore, the user can visually recognize that setting of the first configuration item JS1 is made possible. This may improve user convenience.

The controller 11 according to the present embodiment further includes the third configuration setting unit 114 configured to set, for the third configuration item JS3 that is the configuration item JS included in the third category CT3 different from the first category CT1 and the second category CT2 among the plurality of configuration items JS, a setting value of the third configuration item JS3 of any one of the plurality of documents DC to the third configuration item JS3 of each of the plurality of documents DC. The display control unit 115 is configured to cause the display mechanism 13 to display that setting of the third configuration item JS3 by a user is possible.

According to this configuration, for the third configuration item JS3, which is the configuration item JS included in the third category CT3 different from the first category CT1 and the second category CT2 among the plurality of configuration items JS, the setting value of the third configuration item JS3 of any one of the plurality of documents DC is set to the third configuration item JS3 of each of the plurality of documents DC. Therefore, by appropriately setting the third configuration item JS3, a printed result desired by the user can be obtained. Additionally, the display mechanism 13 is caused to display that setting of the third configuration item JS3 by the user is possible. Therefore, the user can visually recognize with ease that setting of the third configuration item JS3 is possible. This may improve user convenience.

The controller 11 according to the present embodiment includes the configuration item storage unit 119 configured to store whether each of the plurality of configuration items JS is the first configuration item JS1, the second configuration item JS2, or the third configuration item JS3.

According to this configuration, the configuration item storage unit 119 stores whether each of the plurality of configuration items JS is the first configuration item JS1, the second configuration item JS2, or the third configuration item JS3. Therefore, the user can easily confirm whether each of the plurality of configuration items JS is the first configuration item JS1, the second configuration item JS2, or the third configuration item JS3. This may improve user convenience.

A print control method according to the present embodiment is a print control method for controlling combined printing of a plurality of documents DC. The print control method includes setting, for the first configuration item JS1 that is a configuration item included in the first category CT1 among a plurality of configuration items JS specifying processing content of the document DC, the default value DF of the first configuration item JS1 to the first configuration item JS1 of each of the plurality of documents DC; and causing the display mechanism 13 to display that setting of the first configuration item JS1 by a user is not possible.

The print control method according to the present embodiment has the same operations and advantages as the controller 11 according to the present embodiment.

A non-transitory computer-readable storage medium according to the present embodiment storing the control program 117 that causes the processor 11A, included in the controller 11 for controlling combined printing of a plurality of documents DC, to function as the first configuration setting unit 112 setting, for the first configuration item JS1 that is a configuration item included in the first category CT1 among a plurality of configuration items JS specifying processing content of the document DC, the default value DF of the first configuration item JS1 to the first configuration item JS1 of each of the plurality of documents DC; and function as the display control unit 115 causing the display mechanism 13 to display that setting of the first configuration item JS1 by a user is not possible.

The control program 117 according to the present embodiment achieves the same operations and advantages as the controller 11 according to the present embodiment.

### Other Embodiments

The present embodiment illustrates an aspect of the present disclosure and any modification and application without departing from the spirit and scope of the present disclosure may be possible.

In the present embodiment, a description has been given of the case where the printer 1 includes the post-processing device 17; however, the embodiment is not limited to this. For example, the printer 1 may not include the post-processing device 17. Additionally, the printer 1 may be a copier or a multifunction peripheral (MFP).

In the present embodiment, a description has been given of the case where the recording head 151 is an ink jet recording head; however, the embodiment is not limited to this. The recording head 151 may be, for example, a thermal head.

In the present embodiment, a description has been given of the case where the network NW is a LAN; however, the embodiment is not limited to this. The network NW may be, for example, a wide area network (WAN). The network NW may also be, for example, the Internet.

In the present embodiment, a description has been given of the case where, for the first configuration item JS1, the first configuration setting unit 112 sets the default value DF of the first configuration item JS1 to the first configuration item JS1 of each of the plurality of documents DC; however, embodiments are not limited to this.

As depicted in FIG. 3, most of the default values DF of the first configuration items JS1 are set to OFF. Therefore, the first configuration setting unit 112 may set the first configuration item JS1 of each of the plurality of documents DC to OFF.

In the present embodiment, when a plurality of documents DC for combined printing are selected by the user of the personal computer 2, the third configuration setting unit 114 sets the setting value of the third configuration item JS3 in the document data DD corresponding to the document DC selected first for each of the plurality of documents DC; however, the embodiments are not limited to this.

For example, when a plurality of documents DC for combined printing are selected by the user of the personal computer 2, the third configuration setting unit 114 may set the setting value of the third configuration item JS3 in the document data DD corresponding to the document DC selected second for each of the plurality of documents DC.

Additionally, for example, the third configuration setting unit 114 may select one of the plurality of documents DC for the combined printing based on a user operation, and may set the setting value of the third configuration item JS3 in the document data DD corresponding to the selected document DC for each of the plurality of documents DC.

In the present embodiment, a description has been given of the case where the processor 11A included in the printer 1 executes the control program 117 stored in the memory 11B; however, embodiments are not limited to this. The control program 117 may be provided in the form of a recording medium in which the control program 117 is recorded in a computer-readable manner or a transmission medium for transmitting the control program 117.

The recording medium mentioned above may be a magnetic or optical recording medium or a semiconductor memory device. Examples of the recording medium include portable or fixed recording media such as a flexible disk, HDD, a compact disc-read-only memory (CD-ROM), a digital versatile disk (DVD), a Blu-ray® Disc, a magneto-optical disc, a flash memory, and a card-type recording medium.

The recording medium mentioned above may be a nonvolatile storage device such as a RAM, a ROM, or a HDD which is an internal storage device included in the printer 1.

The functions of the controller 11 of the printer 1 may be implemented by a single or a plurality of processors or semiconductor chips. The controller 11 may further include a co-processor such as a System-on-a-Chip (SoC), a micro control unit (MCU), or a FPGA. The controller 11 may perform various kinds of control by causing both the CPU and the co-processor to cooperate with each other, or by selectively using one of the CPU and the co-processor.

Each processing unit of the flowchart of FIG. 6 is divided according to the main processing content in order to easily understand the processing of the controller 11 of the printer 1, and is not limited by the method of dividing the processing unit or the name. Each processing unit of the flowchart may further be divided into processing units according to the processing content. One processing unit may be divided to include more processes. The order of the processes may be changed as appropriate without departing from the spirit and scope of the present disclosure.

Each functional unit illustrated in FIG. 2 indicates a functional configuration, and does not particularly limit a specific implementation form. It is not always necessary to mount hardware individually corresponding to each functional unit, and it is possible to adopt a configuration in which the functions of a plurality of functional units are implemented by one processor executing a program. In the embodiments described above, some of the functions implemented by software may be implemented by hardware, or some of the functions implemented by hardware may be implemented by software. In addition, the specific detailed configuration of each of the other components of the printer 1 can also be appropriately changed without departing from the spirit and scope of the present disclosure.

What is claimed is:

1. A print control apparatus for controlling combined printing of a plurality of documents, the print control apparatus comprising:
a first configuration setting unit configured to set, for a first configuration item that is a configuration item included in a first category among a plurality of configuration items specifying processing content of a document, a default value of the first configuration item to the first configuration item of each of the plurality of documents; and
a display control unit configured to cause a display mechanism to display that setting of the first configuration item by a user is not possible.

2. The print control apparatus according to claim 1, wherein
the display control unit is configured to cause the display mechanism to display, by graying out a first setting button for setting the first configuration item, that the setting of the first configuration item by the user is not possible.

3. The print control apparatus according to claim 1, further comprising
a second configuration setting unit configured to hold, for a second configuration item that is a configuration item included in a second category different from the first category among the plurality of configuration items, a setting value of the second configuration item of each of the plurality of documents, wherein
the display control unit is configured to cause, when the setting of the first configuration item is to be made possible by changing at least one setting value of the second configuration item, the display mechanism to display that the setting of the first configuration item is made possible.

4. The print control apparatus according to claim 3, wherein
when the setting of the first configuration item is made possible by changing the at least one setting value of the second configuration item, the display control unit causes the display mechanism to display that the setting of the first configuration item by the user is made possible.

5. The print control apparatus according to claim 3, further comprising
a third configuration setting unit configured to set, for a third configuration item that is a configuration item included in a third category different from the first category and the second category among the plurality of configuration items, a setting value of the third configuration item of any one of the plurality of documents to the third configuration item of each of the plurality of documents, wherein
the display control unit is configured to cause the display mechanism to display that setting of the third configuration item by the user is possible.

6. The print control apparatus according to claim 5, further comprising
a configuration item storage unit configured to store whether each of the plurality of configuration items is the first configuration item, the second configuration item, or the third configuration item.

7. A print control method for controlling combined printing of a plurality of documents, the print control method comprising:
setting, for a first configuration item that is a configuration item included in a first category among a plurality of configuration items specifying processing content of a document, a default value of the first configuration item to the first configuration item of each of the plurality of documents; and
causing a display mechanism to display that setting of the first configuration item by a user is not possible.

8. A non-transitory computer-readable storage medium storing a program that causes a processor, included in a print control apparatus for controlling combined printing of a plurality of documents, to function as:
a first configuration setting unit setting, for a first configuration item that is a configuration item included in a first category among a plurality of configuration items specifying processing content of a document, a default value of the first configuration item to the first configuration item of each of the plurality of documents; and
a display control unit causing a display mechanism to display that setting of the first configuration item by a user is not possible.
